(19) United States
(12) Patent Application Publication
(10) Pub. No.: US 2019/0146775 A1
(43) Pub. Date: May 16, 2019

(54) SYSTEM AND METHOD FOR A SECURE UPDATE OF DRIVERS OR DATA FOR VEHICLE ELECTRONIC EQUIPMENT

(71) Applicant: Industrial Technology Research Institute, Hsinchu (TW)

(72) Inventors: Yung-Chen WANG, Kaohsiung City (TW); Bo-Lin SUNG, Hsinchu City (TW)

(21) Appl. No.: 15/854,646

(22) Filed: Dec. 26, 2017

(30) Foreign Application Priority Data
Nov. 15, 2017 (TW) 106139475

(51) Int. Cl. G06F 8/65; H04L 29/06; G06F 8/61; G06F 17/30; H04L 29/08

(52) U.S. Cl. CPC G06F 8/65; H04L 63/123; H04L 67/12; G06F 17/30371; H04L 67/34; G06F 8/61

(57) ABSTRACT

A system for a secure update of drivers or data for vehicle electronic equipment is provided. The system includes a network communication device and a controller. The network communication device receives an update file of the vehicle electronic equipment via an Internet connection. The controller uses a pre-loaded simulator to simulate the vehicle electronic equipment operating with the update file and to generate simulation data. Also, the controller determines whether the simulation data matches a predetermined condition, and installs the update file to the vehicle electronic equipment when the simulation data matches the predetermined condition.

### CROSS REFERENCE TO RELATED APPLICATION

This Application claims priority of Taiwan Patent Application No. 106139475, filed on Nov. 15, 2017, the entirety of which is incorporated by reference herein.

### TECHNICAL FIELD

The disclosure generally relates to techniques for updating drivers or data of vehicle electronic equipment, and to a system and a method thereof for a secure update of drivers or data for vehicle electronic equipment by pre-loading simulators to perform security checks on the update files before installing them to the vehicle electronic equipment.

### BACKGROUND

With growing demand for ubiquitous computing and networking, various wireless technologies have been developed, such as the Wireless Local Area Network (WLAN) technology and telecommunication technologies. The WLAN technology is also called the Wireless Fidelity (WiFi) technology. The telecommunication technologies include Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, Time-Division LTE (TD-LTE) technology, and LTE-Advanced (LTE-A) technology, etc.

Due to the rapid development of wireless technologies, related applications have become widespread, and most vehicles nowadays support the function of wireless communications which allow software and firmware updates of the vehicle's electronic equipment through an Over the Air (OTA) technique. Conventionally, the OTA technique only provides reliable data transfer by encrypting and decrypting the update files, and does not verify that the update files satisfy the security requirements of the vehicle electronic equipment. Once an update file that does not satisfy the security requirements gets installed to the vehicle electronic equipment, unpredictable errors or driving hazards may occur.

Therefore, it is desirable to have a more robust method for updating the vehicle electronic equipment, which can verify the security of update files before installing them to the vehicle electronic equipment and avoid the aforementioned problems caused by installing update files that fail to satisfy security requirements.

### SUMMARY

In order to solve the aforementioned problems, the application proposes a system and a method thereof for a secure update of driver or data for vehicle electronic equipment, which use simulators pre-loaded in the vehicles to verify the security of the update files, i.e., the drivers and/or the data, of the vehicle electronic equipment.

In one aspect of the application, a system for a secure update of drivers or data for vehicle electronic equipment is provided. The system comprises a network communication device and a controller. The network communication device is configured to receive an update file of vehicle electronic equipment via an Internet connection. The controller is configured to use a pre-loaded simulator for simulating the vehicle electronic equipment operating with the update file and generating simulation data, determine whether the simulation data matches a predetermined condition, and install the update file to the vehicle electronic equipment when the simulation data matches the predetermined condition

In another aspect of the application, a method for a secure update of drivers or data for vehicle electronic equipment, executed by a system capable of network communications is, provided. The method comprises the steps of: receiving an update file of a vehicle electronic equipment via an Internet connection; using a pre-loaded simulator for simulating the vehicle electronic equipment operating with the update file and generating simulation data; determining whether the simulation data matches a predetermined condition; and installing the update file to the vehicle electronic equipment when the simulation data matches the predetermined condition.

Other aspects and features of the disclosure will become apparent to those with ordinary skill in the art upon review of the following descriptions of specific embodiments of the systems and methods for a secure update of drivers or data for vehicle electronic equipment.

### BRIEF DESCRIPTION OF DRAWINGS

The disclosure can be more fully understood by reading the subsequent detailed description and examples with references made to the accompanying drawings, wherein:

FIG. 1 is a block diagram illustrating a network communication environment according to an embodiment of the application;

FIG. 2 is a block diagram illustrating the vehicle 130 according to an embodiment of the application; and

FIG. 3 is a flow chart illustrating the method for a secure update of drivers or data for vehicle electronic equipment according to an embodiment of the application.

### DETAILED DESCRIPTION OF THE APPLICATION

The following description is made for the purpose of illustrating the general principles of the application and should not be taken in a limiting sense. It should be understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

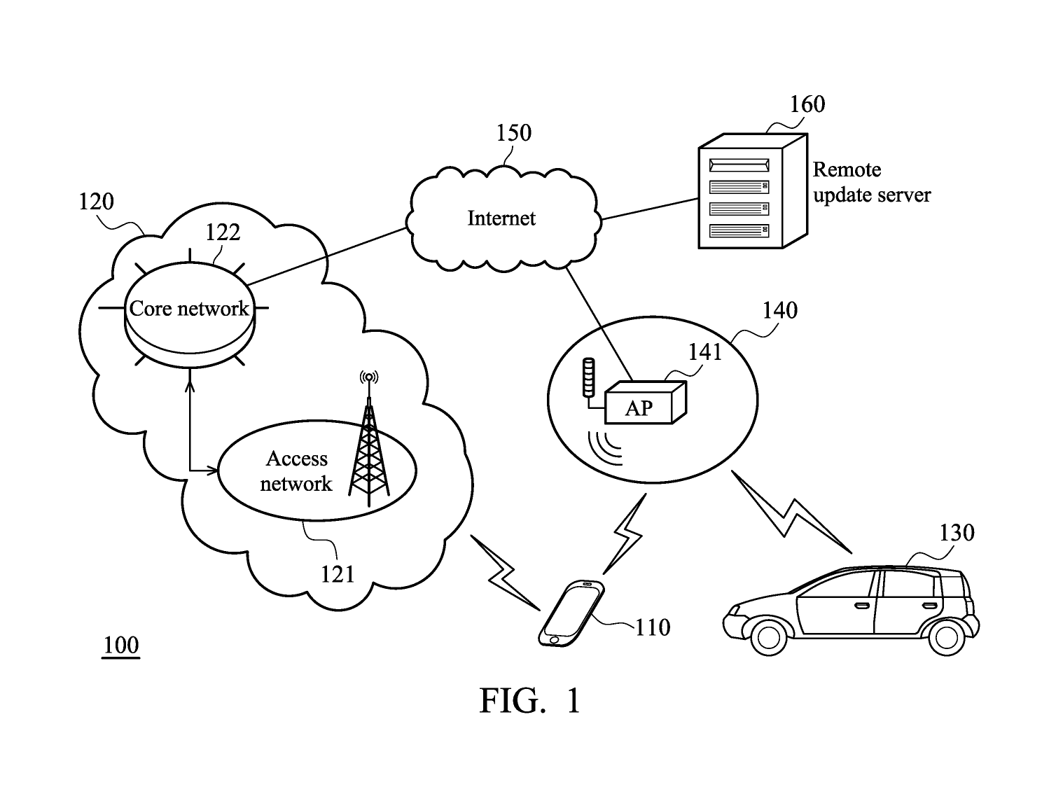

FIG. 1 is a block diagram illustrating a network communication environment according to an embodiment of the application. The network communication environment 100 includes a mobile communication device 110, a telecommunication network 120, a vehicle 130, a WLAN 140, the Internet 150, and a remote update server 160.

The mobile communication device 110 may be a smartphone, Personal Computer (PC), laptop computer, panel PC, or any computing device supporting the telecommunication technology utilized by the telecommunication network 120 and/or the WiFi technology utilized by the WLAN 140. The mobile communication device 110 may connect to the Internet 150 via the telecommunication network 120 or the WLAN 140, and then connect to the remote update server 160 via the Internet 150 to request online updates of the software or firmware (e.g., drivers) of the vehicle electronic equipment of the vehicle 130. It should be understood that the software or firmware (e.g., drivers) of the vehicle electronic equipment may be updated offline instead, by using a storage medium, such as a memory card or optical disc, which contains the update files.

The telecommunication network 120 may be a GSM network, GPRS network, EDGE network, WCDMA) network, CDMA-2000 network, TD-SCDMA network, WiMAX network, LTE network, TD-LTE network, or LTE-A network, depending on the telecommunication technology in use. Specifically, the telecommunication network 120 includes an access network 121 and a core network 122, wherein the access network 121 is responsible for processing radio signals, terminating radio protocols, and connecting the mobile communication device 110 with the core network 122, while the core network 122 is responsible for performing mobility management, network-side authentication, and interfaces with public/external networks (e.g., the Internet 150).

The vehicle 130 is a transportation means capable of network communications. For example, the vehicle 130 may support at least the WiFi technology utilized by the WLAN 140. The vehicle 130 may connect to the Internet 150 via the WLAN 140, and then connect to the remote update server 160 via the Internet 150 to receive the update file of the vehicle electronic equipment. Alternatively, in another embodiment, the vehicle 130 may support the telecommunication technology utilized by the telecommunication network 120, and it may connect to the Internet 150 via the telecommunication network 120, and then connect to the remote update server 160 via the Internet 150 to receive the update file of the vehicle electronic equipment.

It should be understood that the vehicle 130 depicted as a car in FIG. 1 is for illustrative purposes only and is not intended to limit the scope of the application. For example, the vehicle 130 may be any transportation means, such as a motorcycle, a scooter, a truck, a van, a train, an airplane, or a ship, as long as it is capable of network communications.

The WLAN 140 is established by an AP 141 utilizing the WiFi technology. Specifically, the AP 141 may connect to a local area network by an Ethernet cable, and then connect to the Internet 150. The AP 141 typically receives, buffers, and transmits data between the WLAN 140 and the mobile communication device 110 and/or the vehicle 130.

The remote update server 160 is responsible for maintaining the update files of the vehicle electronic equipment of the vehicle 130, and providing a web interface for the user of the mobile communication device 110 and the vehicle 130 to request updates of the vehicle electronic equipment. When the manufacturer of the vehicle electronic equipment releases a new version of software/firmware (e.g., drivers), they may upload the update file to the remote update server 160. After that, the remote update server 160 may use the push notification service to notify the mobile communication device 110 of the availability of the update file. When receiving the notification, the user may request updating the vehicle electronic equipment via the web interface provided by the remote update server 160. Upon receiving the update request, the remote update server 160 encrypts and sends the update file to the vehicle 130. Alternatively, the user may download the update file to a storage medium and then upload the update file to the vehicle 130 from the storage medium.

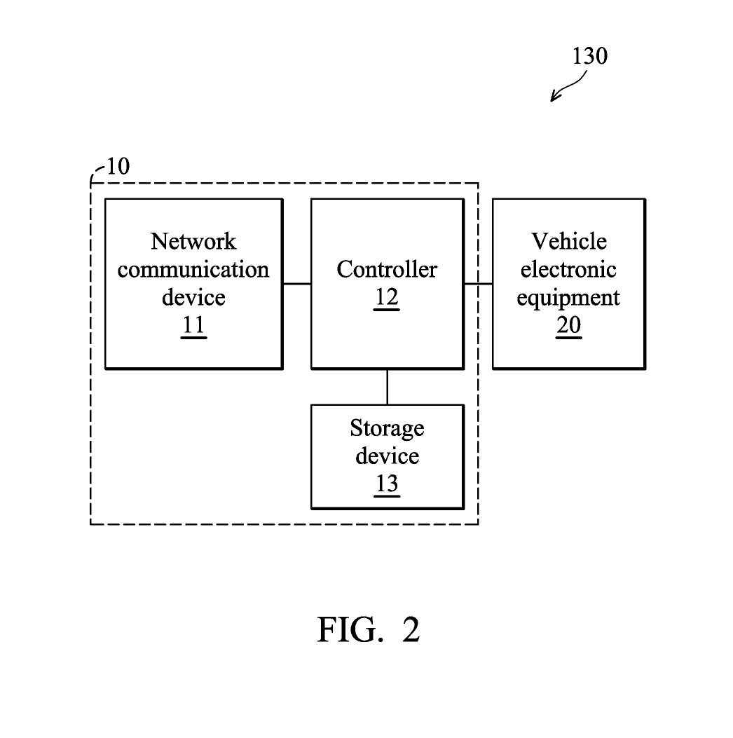

FIG. 2 is a block diagram illustrating the vehicle 130 according to an embodiment of the application. The vehicle 130 at least includes an update system 10 and vehicle electronic equipment 20, wherein the update system 10 is responsible for controlling the operations of the vehicle electronic equipment 20 and updating the software/firmware (e.g., drivers) of the vehicle electronic equipment 20.

Specifically, the update system 10 includes a network communication device 11, a controller 12, and a storage device 13. The network communication device 11 provides the function of wireless transmission and reception to and from the WLAN 140, and connects the update system 10 to the remote update server 160 via the Internet connection provided by the WLAN 140. For example, the network communication device 11 may be a wireless transceiver including a Radio Frequency (RF) device, a baseband processing device, and an antenna. The baseband processing device may contain multiple hardware components to perform the baseband signal processing, including Analog-to-Digital Conversion (ADC)/Digital-to-Analog Conversion (DAC), gain adjusting, modulation/demodulation, encoding/decoding, and so on. The RF device may receive RF wireless signals via the antenna, convert the received RF wireless signals to baseband signals, which are processed by the baseband processing device, or receive baseband signals from the baseband processing device and convert the received baseband signals to RF wireless signals, which are later transmitted via the antenna. The RF device may also contain multiple hardware devices to perform radio frequency conversion. For example, the RF device may comprise a mixer to multiply the baseband signals with a carrier oscillated in the radio frequency of the supported wireless technologies, wherein the radio frequency may be 2.4 GHz or 5 MHz utilized in the WiFi technology, or another radio frequency, depending on the wireless technology in use.

In another embodiment, the network communication device 11 may also provide the function of wired communications to connect to the Internet 150 through an Ethernet, optical network, or Asymmetric Digital Subscriber Line (ADSL) network, and then connect to the remote update server 160 via the Internet 150.

The controller 12 may be a general-purpose processor, a Micro Control Unit (MCU), an application processor, a Digital Signal Processor (DSP), or the like, which includes various circuits for providing the functions of data processing and computing, providing the function of On-Board Diagnostics (OBD) (e.g., Unified Diagnostic Service (UDS)), controlling the network communication device 11 for communications with the remote update server 160, storing and retrieving data (e.g., the update file of the vehicle electronic equipment 20) to and from the storage device 13, and controlling the operations of the vehicle electronic equipment 20. In particular, the controller 12 coordinates the operations of the network communication device 11, the storage device 13, and the vehicle electronic equipment 20 for performing the method for a secure update of drivers or data for vehicle electronic equipment.

As will be appreciated by persons skilled in the art, the circuits in the controller 12 will typically comprise transistors that are configured in such a way as to control the operation of the circuitry in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 13 is a non-transitory computer-readable storage medium, such as a memory (e.g., Random Access Memory (RAM), FLASH memory, or Non-volatile Random Access Memory (NVRAM)), a magnetic storage device (e.g., hard disk or magnetic tape), an optical disc (e.g., Compact Disc Read-Only Memory, CD-ROM), or any combination thereof, for storing a pre-loaded simulator, one or more predetermined conditions, the update file, and instructions or program code of the method for a secure update of drivers or data for vehicle electronic equipment.

The vehicle electronic equipment 20 may include a power train and a body train. The power train may include at least one of: a battery pack, a voltage converter, and a motor. The body train may include at least one of: an Electronic Stability Program (ESP) system, an Electronic Stability Control (ESC) system, a seat positioning system, a key ID transmitter, and an internal control system. To further clarify, the controller 12 may use the UDS to update the software/firmware (e.g., drivers) of the vehicle electronic equipment 20.

It should be understood that the components described in the embodiment of FIG. 2 are for illustrative purposes only and are not intended to limit the scope of the application. For example, the update system 10 may be implemented as an add-on component or detachable component which is attached to the vehicle 130 only when the user wishes to update the software/firmware (e.g., drivers) of the vehicle electronic equipment 20. That is, the vehicle 130 may provide the function of transportation without the update system 10. Alternatively, the vehicle 130 may include more components, such as a display device (e.g., a Liquid-Crystal Display (LCD), Light-Emitting Diode (LED), or Electronic Paper Display (EPD)), an Input/Output (I/O) device (e.g., one or more buttons, a keyboard, a touch pad, a microphone, a speaker, and/or a card reader or optical drive for reading the update file from a storage medium), and/or a Global Positioning System (GPS).

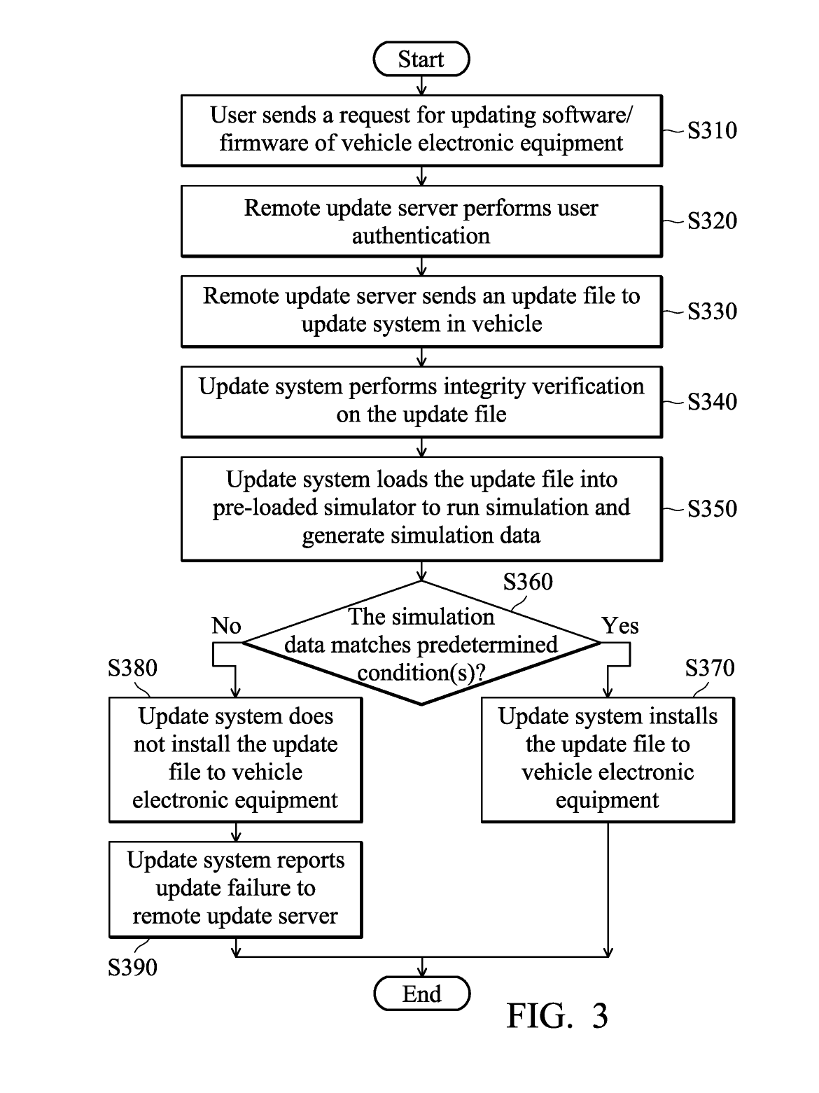

FIG. 3 is a flow chart illustrating the method for a secure update of drivers or data for vehicle electronic equipment according to an embodiment of the application. For convenience of understanding the method for a secure update of drivers or data for vehicle electronic equipment, the detailed description thereof is given below using the network communication environment 100 in FIG. 1 as an exemplary environment.

To begin, the user sends a request to the remote update server 160 via the mobile communication device 110 for updating the software/firmware (e.g., drivers) of the vehicle electronic equipment 20 in the vehicle 130 (step S310). Specifically, the mobile communication device 110 may access the web interface provided by the remote update server 160, through which the user may request an update of the software/firmware (e.g., drivers) of the vehicle electronic equipment 20.

Next, the remote update server 160 performs user authentication on the requesting user (step S320). Specifically, the user authentication may include authenticating the identity of the user. For example, the user may register with the remote update server 160 after purchasing the vehicle 130, wherein the registration information may include the account, the password, and the equipment information (e.g., equipment identification) of the vehicle 130. Subsequently, when the user wishes to update the software/firmware (e.g., drivers) of the vehicle electronic equipment 20, he/she may input the registered account and password to log in to the web interface provided by the remote update server 160, and then indicate which vehicle electronic equipment to update. The remote update server 160 may check if the user corresponding to the inputted account and password has permission to update the indicated vehicle electronic equipment.

After the user authentication has been successfully completed, the remote update server 160 sends the update file to the update system 10 in the vehicle 130 (step S330). In one embodiment, the update file may be sent with the protection of a specific encryption algorithm. That is, the sender (e.g., the remote update server 160) may use an encryption algorithm to encrypt the update file before sending it, and the receiver (e.g., the update system 10) may use the same encryption algorithm to decrypt the received data and obtain the update file.

When receiving the update file, the update system 10 performs integrity verification on the update file (step S340). Specifically, the integrity verification may include performing a Cyclic Redundancy Check (CRC) on the update file, or using a Secure Hash Algorithm (SHA) to verify the update file.

After the integrity verification has been successfully completed, the update system 10 loads the update file into the pre-loaded simulator to run a simulation and generate simulation data (step S350). Subsequently, the update system 10 determines whether the simulation data matches the predetermined condition(s) (step S360). The simulation run by the pre-loaded simulator specifically refers to simulating the vehicle electronic equipment operating with the update file. To further clarify, the pre-loaded simulator may be divided into two parts, wherein the first part includes a plant model established for simulating the operations of the vehicle electronic equipment 20, and the second part includes various test cases for testing the plant model using different control parameters. The test results obtained from the testing may be recorded as the predetermined condition(s).

For example, the vehicle electronic equipment 20 may include at least one of: a battery pack (e.g., a Nickel-metal hybrid battery pack, or a Lithium-ion battery pack), a voltage converter (e.g., a high-efficiency and bi-directional DC-to-DC converter), and a motor (e.g., an integrated starter generator, or a Permanent-Magnet Synchronous Motor (PMSM)).

Correspondingly, the simulation data generated from each simulation may include at least one of: the voltage level of the battery pack, the current value of the battery pack, and the pole value of the motor. The predetermined condition(s) may include at least one of: the valid range of the voltage level, the valid range of the current value, and the valid range of the pole value.

In one embodiment, the pre-loaded simulator and the predetermined condition(s) may be burned or loaded into the update system 10 (e.g., the storage device 13) in response to the vehicle 130 completing the factory assembly and testing process.

Subsequent to step S360, when the simulation data matches the predetermined condition(s), the update system 10 installs the update file to the vehicle electronic equipment 20 (step S370), and the method ends.

In one embodiment, the OBD function of the update system 10 may include an offline burner module which the update file is first loaded into and then installed to the vehicle electronic equipment 20 through.

Subsequent to step S360, when the simulation data does not match the predetermined condition(s), the update system 10 does not install the update file to the vehicle electronic equipment 20 (step S380), and then reports the update failure to the remote update server 160 (step S390), and the method ends.

In view of the foregoing embodiment of FIG. 3, it will be appreciated that, unlike the convention update method using the OTA technique which only provides reliable data transfer, method for a secure update of drivers or data for vehicle electronic equipment proposed in the present application can verify the security of update files before installing them to the vehicle electronic equipment. Advantageously, the unfavorable situations caused by installing update files failing to satisfy the security requirements may be avoided.

While the application has been described by way of example and in terms of preferred embodiment, it should be understood that the application cannot be limited thereto. Those who are skilled in this technology can still make various alterations and modifications without departing from the scope and spirit of this application. Therefore, the scope of the present application shall be defined and protected by the following claims and their equivalents.

Note that use of ordinal terms such as “first”, “second”, “third”, etc., in the claims to modify a claim element does not by itself connote any priority, precedence, or order of one claim element over another or the temporal order in which acts of the method are performed, but are used merely as labels to distinguish one claim element having a certain name from another element having the same name (except for use of ordinal terms), to distinguish the claim elements.

What is claimed is:

1. A system for a secure update of drivers or data for vehicle electronic equipment, comprising:
a network communication device, configured to receive an update file of vehicle electronic equipment via an Internet connection; and
a controller, configured to use a pre-loaded simulator for simulating the vehicle electronic equipment operating with the update file and generating simulation data, determine whether the simulation data matches a predetermined condition, and install the update file to the vehicle electronic equipment when the simulation data matches the predetermined condition.

2. The system of claim 1, wherein the controller is further configured to perform an integrity verification on the update file, and perform the simulation when the integrity verification has been completed successfully.

3. The system of claim 2, wherein the integrity verification comprises performing a Cyclic Redundancy Check (CRC) on the update file, or using a Secure Hash Algorithm (SHA) to verify the update file.

4. The system of claim 1, wherein the vehicle electronic equipment comprises at least one of: a battery pack, a voltage converter, and a motor; the simulation data comprises at least one of: a voltage level of the battery pack, a current value of the battery pack, and a pole value of the motor; and the predetermined condition comprises at least one of: a first valid range of the voltage level, a second valid range of the current value, and a third valid range of the pole value.

5. The system of claim 1, wherein the controller is further configured to not install the update file to the vehicle electronic equipment when the simulation data does not match the predetermined condition.

6. A method for a secure update of drivers or data for vehicle electronic equipment, executed by a system capable of network communications, the method comprising:
receiving an update file of vehicle electronic equipment via an Internet connection;
using a pre-loaded simulator for simulating the vehicle electronic equipment operating with the update file and generating simulation data;
determining whether the simulation data matches a predetermined condition; and
installing the update file to the vehicle electronic equipment when the simulation data matches the predetermined condition.

7. The method of claim 6, further comprising:
performing an integrity verification on the update file; and
performing the simulation when the integrity verification has been completed successfully.

8. The method of claim 7, wherein the integrity verification comprises performing a Cyclic Redundancy Check (CRC) on the update file, or using a Secure Hash Algorithm (SHA) to verify the update file.

9. The method of claim 6, wherein the vehicle electronic equipment comprises at least one of: a battery pack, a voltage converter, and a motor; the simulation data comprises at least one of: a voltage level of the battery pack, a current value of the battery pack, and a pole value of the motor; and the predetermined condition comprises at least one of: a first valid range of the voltage level, a second valid range of the current value, and a third valid range of the pole value.

10. The method of claim 6, further comprising:
not installing the update file to the vehicle electronic equipment when the simulation data does not match the predetermined condition.
